(19) United States
(12) Patent Application Publication
(10) Pub. No.: US 2010/0255455 A1
(43) Pub. Date: Oct. 7, 2010

(54) Adaptive Assessment

(76) Inventors: Steven C. Velozo, Seattle, WA (US); Ramona J. Pierson, San Jose, CA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 12/732,026

(22) Filed: Mar. 25, 2010

Related U.S. Application Data
(63) Continuation-in-part of application No. 12/546,496, filed on Aug. 24, 2009.
(60) Provisional application No. 61/166,624, filed on Apr. 3, 2009.

(51) Int. Cl. G09B 7/00

(52) U.S. Cl. 434/362

(57) ABSTRACT

Described is a system, method, and product for adaptive assessment of knowledge. One or more questions are generated by combining, for each question: an item, a correct answer, a distracter (incorrect answer), a path for the distracter, and a standard alignment for the item. The questions are stored in a question database. An item associated with a question in the database is presented. A distracter is received in response to the item. The path for the distracter is identified. One or more next questions are retrieved from the question database, and one or more next items are presented, wherein the one or more next items are associated with the path.

### CROSS-REFERENCE TO RELATED APPLICATIONS

This application claims the benefit of Provisional Patent Application Ser. No. 61/166,624, filed Apr. 3, 2009, for all purposes including but not limited to the right of priority and benefit of earlier filing date, and expressly incorporates by reference the entire content of Provisional Patent Application Ser. No. 61/166,624.

This application is a Continuation-In-Part of patent application Ser. No. 12/546,496, filed Aug. 24, 2009, for all purposes including but not limited to the right of priority and benefit of earlier filing date, and expressly incorporates by reference the entire content of patent application Ser. No. 12/546,496 for all purposes.

### BACKGROUND

Traditionally, schools have adopted forms of testing that fail to provide an accurate representation of students' academic strengths and weakness. The standard “brute force” testing model provides a rigid set of questions which a student is expected to answer, and which cannot be adapted in real time to the student's responses. Further, the standard model does not provide opportunities for immediate remediation of a student's academic deficiencies.

Unfortunately, an adaptive assessment method that makes it possible to generate an in-depth, real-time assessment of a student's strengths and weaknesses has eluded those skilled in the art, until now.

### SUMMARY

The present invention provides a method for adaptive assessment of knowledge, and a system and product for its implementation.

### BRIEF DESCRIPTION OF THE DRAWINGS

FIG. 1 illustrates by way of a block diagram one embodiment of the present method, system, and product for adaptive assessment.

FIG. 2 is a functional block diagram illustrating in greater detail one implementation of a representative question 107 introduced in conjunction with FIG. 1.

FIG. 3 is a functional block diagram illustrating in greater detail one implementation of the map 108 introduced in conjunction with FIG. 1.

FIG. 4 illustrates by way of a directed graph diagram another embodiment of the present method, system, and product for adaptive assessment.

FIG. 5 illustrates by way of a schematic flow diagram yet another embodiment of the present method, system, and product for adaptive assessment.

FIG. 6 illustrates by way of a schematic flow diagram still another embodiment of the present method, system, and product for adaptive assessment.

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like. Without limitation, the data described herein may be stored in (and accessed via) the data warehouse described in U.S. patent application Ser. No. 12/546,496, now U.S. Pat. No. ______.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in learning environments of any type. Unless explicitly stated, the method embodiments described herein are not constrained to a particular order or sequence. Additionally, some of the described method embodiments or elements thereof can occur or be performed at the same point in time.

The various embodiments described herein are directed to a method, system, and product for adaptive assessment of knowledge. Briefly stated, the present embodiment allows one or more questions to be generated by combining, for each question: an item comprising a query for student response (for example and without limitation: “A large square is divided into same-size smaller squares as shown below. What is the area of the shaded region?”), a correct answer, one or more distracters (incorrect answers), a path for the distracter, and a standard alignment for the item. (Correct answers and distracters provided with respect to any particular item are referred to herein as the “potential responses” to that item.) Each item may have its own respective UID (unique identifier), which may take any form capable of uniquely identifying an item, including but not limited to a GUID (globally unique identifier). In this application, “standard” refers to any type of standard which permits the assessment of a student's knowledge. By way of example and without limitation, the following standards are taken from the current version of the Indiana Department of Education's Academic Standards for mathematics, grade 4, standard 1:

4.1.1—Read and write whole numbers up to 1,000,000.

4.1.2—Identify and write whole numbers up to 1,000,000, given a place-value model.

4.1.3—Round whole numbers up to 10,000 to the nearest ten, hundred, and thousand.

4.1.4—Order and compare whole numbers using symbols for “less than” (<), “equal to” (=), and “greater than” (>).

4.1.5—Rename and rewrite whole numbers as fractions.

Accordingly, a “standard alignment” for an item indicates that the item is aligned with one or more standards—that is, the item is designed to test a student's knowledge of the material associated with the standards with which the item is aligned. Each distracter has its own respective path, which indicates the standards the student does not meet if the student chooses that particular distracter in response to the item. Each path may take the form of one or more standards, and one or more items related to those standards may be presented in the event the student chooses the distracter associated with that path. Alternatively, any particular path may take the form of one or more UIDs associated with one or more questions which are desired to be presented to the student in the event the student chooses the distracter associated with that path.

In the present embodiment, one or more questions are stored in a question database. An item associated with a question in the database is presented. In the event a distracter is received in response to the item, the path for the distracter is identified. One or more next questions are retrieved from the question database, and one or more next items are presented, wherein the one or more next items are associated with the path. The assessment results—i.e., the student's responses to the questions presented during the assessment—may be used to generate a student information file, which may be stored in a student information database. Alternatively, the assessment results may be stored within a pre-existing student information file in the student information database. An analysis engine may be used to generate an analysis of an individual student's responses, which analysis may provide an in-depth representation of the student's strengths and weaknesses as confirmed by the student's responses to items specifically adapted to the student's responses. The analysis engine may also be used to analyze the strengths and weaknesses of a particular class, school, or any other group in relation to any form of knowledge which may be tested by the various embodiments described herein.

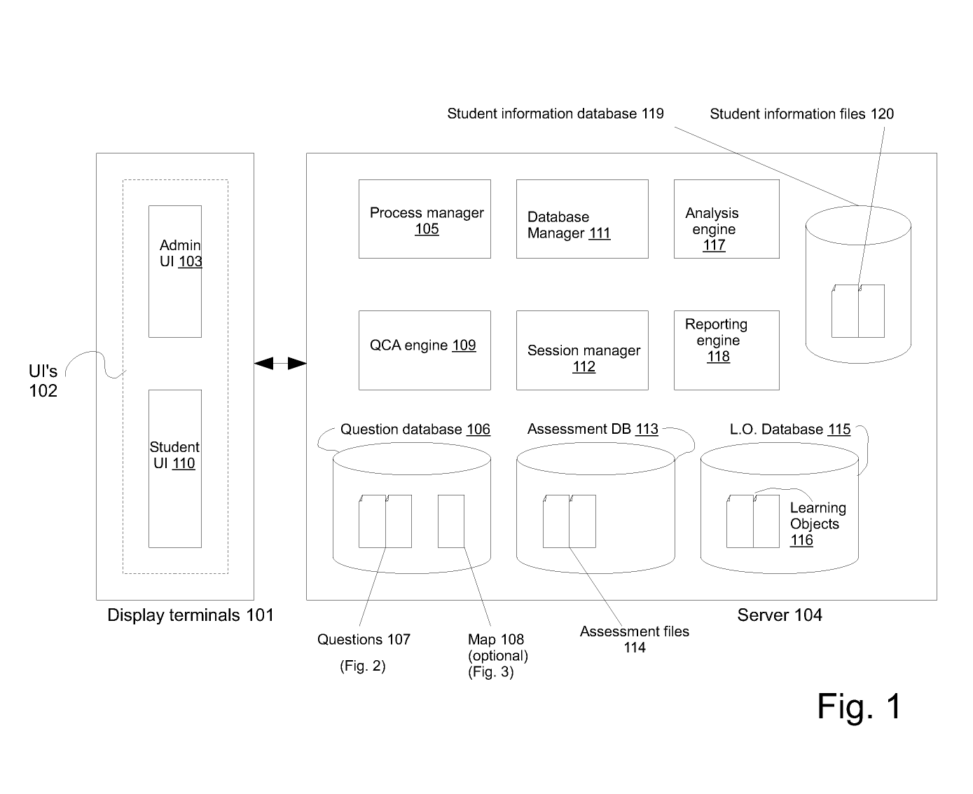

Referring now to FIG. 1, there is shown in the form of a block diagram one embodiment of an aspect of the present embodiment for adaptive assessment. In the embodiment shown, server 104 is in communication with one or more display terminals 101. Server 104 may be directly connected to display terminals 101. Alternatively, server 104 may be in communication with display terminals 101 via the Internet or any other means of remote communication. Any combination of data storage devices, including without limitation computer servers, using any combination of programming languages and operating systems that support network connections, is contemplated for use in the present inventive method, system, and product. By way of example and without limitation, the Microsoft .NET framework may be used. The inventive method, system, and product are also contemplated for use with any communication network, and with any method or technology which may be used to communicate with said network, including without limitation wireless fidelity networks, Ethernet, Universal Serial Bus (USB) cables, TCP/IP wide-area networks, the Internet, and the like.

In the embodiment shown, two user interfaces (UI's) 102 are depicted—an administrator (“admin”) UI 103 and a student UI 110. UI's 102 may take the form of one or more web browsers, or any other means by which audio, video, text and/or other content may be displayed, and by which data may be received. UI's 102 may be used in connection with one or more display terminals. In one embodiment, admin UI 103 and student UI 110 may be the same user interface, and may alternatively operate as admin UI 103 and student 110 at different times, possibly after requiring separate logins for a teacher and a student.

UI's 102 may be rendered by a conventional web browser or by any other known method or means—for example and without limitation, Asynchronous Javascript and XML (AJAX). Styling may be accomplished via CSS style sheets or any other technique. Custom templates may allow users to alter the graphical representations of the data presented via UI's 102 to suit their particular needs or desires.

In the embodiment shown, process manager 105 oversees the processes relating to the present method, system, and product for adaptive assessment. Process manager 105 retrieves and transmits data in accordance with the operations indicated at admin UI 103 or student UI 110. Session manager 112 governs the presentation and selection of questions during an assessment. “Assessment” as used herein refers to a series of questions presented for student response. Database manager 111 retrieves data from one or more databases as required and, in communication with process manager 105, causes data to be displayed by the appropriate UI 102.

An individual, such as a teacher or school administrator (in this particular example, without limitation, a teacher), or a group, may use one or more admin UI's 103 to access question creation and alignment engine (“QCA engine”) 109 via process manager 105. QCA engine 109 may permit the teacher to create one or more new questions 107 by providing the following for each respective question: an item, a standard alignment, a correct answer, one or more distracters, and one or more paths, each distracter having its own respective path. Alternatively, one or more questions may be pre-aligned with one or more standards and/or UIDs, and/or one or more distracters may be pre-aligned with one or more standards and/or UIDs. A path may optionally be provided for the correct answer. QCA engine 109 may include a visual editor which allows the teacher to create one or more items including one or more of the following: images, textual excerpts, videos, sounds, and/or other interactive media. The standards used for aligning items and/or distracters within questions 107 may include, by way of example and without limitation, state standards, Bloom's Taxonomy, grade level standards, subject standards, or any other taxonomical standards, as well as custom criteria which may take any conceivable form. Questions 107 are stored in question database 106.

If a question 107 (or a distracter) is aligned with more than one standard, QCA engine 109 may be used to choose the relative weight of each standard, as determined by the standard's relevance to the question (or the distracter). For example and without limitation, one particular question may be weighted with 65% relevance to a first standard, and 35% relevance to a second standard. Questions 107 may include any data and be in the form of any data files including but not limited to XML files, JS files, CSS files, SQL (Structured Query Language) files, and PL/SQL (Procedural Language/Structured Query Language) files.

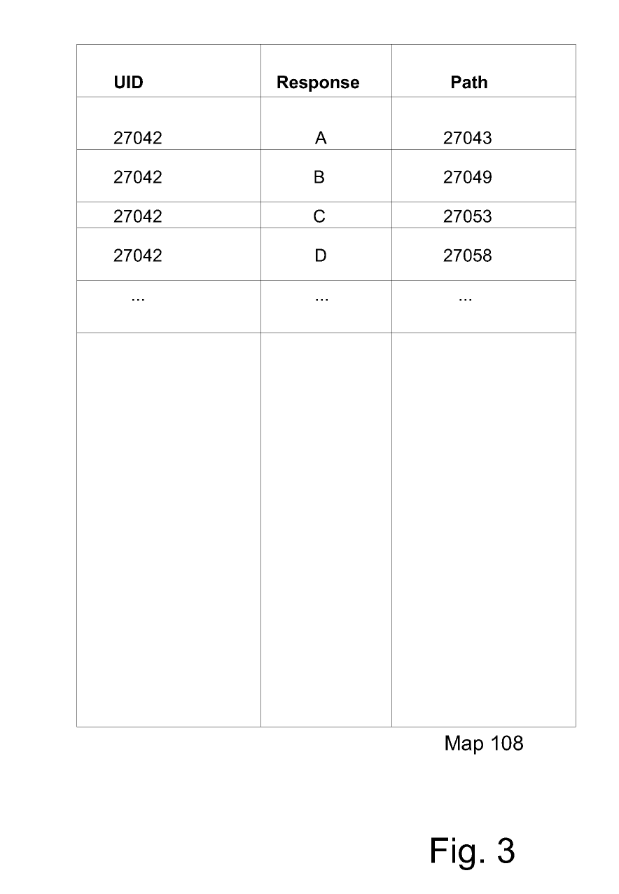

Prior to an assessment session, session manager 112 may receive communications from one or more of UI's 102 directing session manager 112 to select an appropriate group of questions determined by grade level, subject, and/or other criteria determined by one or more users of the embodiment shown. In that event, session manager 112 may create an assessment file (a list that identifies certain questions 107 that are related or otherwise grouped for a particular purpose) and present a first item (as determined by the created assessment file) in connection with one or more distracters, each distracter having its own particular path. When a distracter is received in response to an item, session manager 112 may select a next question from the question database, using the received distracter's path as well as the other criteria provided to select the next question. There is optionally provided a map 108 (more fully described in FIG. 3 below) which indicates the path to be taken when specific distracters are received in response to specific items.

Alternatively, for any given assessment, session manager 112 may receive communications from one or more of UI's 102 directing session manager 112 to present questions from a designated assessment file 114. Assessment files 114 are stored at assessment database 113. A teacher (or another individual, or a group) may create an assessment file 114 by using QCA engine 109 to create a list of questions from which an assessment may be generated. QCA engine 109 may, via process manager 105, cause admin UI 103 to render a simple drag-and-drop interface, allowing one or more items to be organized into sections with ease when generating an assessment file 114. One or more items may be aligned with one or more standards via a tree interface or other desired interface. One or more assessment files 114 may be created with multiple segments for easy assignment to school districts, programs, schools, departments, specific teachers, or even specific students. Any particular assessment may be proctored digitally, via one or more admin UI's 103, and may be scored via electronic or other means, including but not limited to scoring by hand.

An individual, such as a student, or a group, such as a class may use one or more student UI's 110 to access session manager 112 via process manager 105. Session manager 112 may receive relevant data, such as the student's identity and/or the particular assessment which the student wishes to take. Session manager 112 may store the relevant data in a student information file 120, stored at student information database 119. Session manager 112 may create a new student information file 120 or, alternatively, may add the relevant data (including the student's responses to one or more assessments) to a pre-existing student information file 120.

During an assessment, session manager 112 may determine that a student (or class, or other group) would benefit by receiving immediate remedial support. For example and without limitation, an algorithm associated with session manager 112 may indicate that a student has significant weaknesses in connection with standard “4.1.2.” At that point, session manager 112 may cause one or more of learning objects 116 to be presented to the student via student UI 110. A “learning object” comprises material designed to assist one or more students in learning the material associated with a particular standard. For example and without limitation, if standard “4.1.2” is “can apply the Pythagorean theorem”, a relevant learning object may request the student to pause the assessment, step outside with a ruler, and use the Pythagorean theorem to measure the height of a nearby tree, consult with the student's teacher, then return to the assessment. Learning objects may include, but are not limited to, interactive curricula, reading materials, group activities, or any other material or activity designed to increase the knowledge of one or more students. One or more learning objects 116 may be stored in learning object (“L.O.”) database 115. Alternatively, a student's teacher may monitor the student's progress in real time via admin UI 103, and may approach the student for immediate real-time intervention upon discovering the student lacks comprehension of the material associated with a particular standard. (This is merely an illustrative example; it is to be understood that the current embodiment may also apply to a class or other group.) Remediation may be provided during the assessment or, alternatively, after the assessment is completed.

After a student (or class, or other group) has completed an assessment and the responses are stored in one or more student information files 120, an individual or group may use one or more admin UI's 103 to cause analysis engine 117 to analyze one or more student information files 120. Analysis engine 117 may perform any type of statistical, comparative, or other analysis of one or more student information files 120 and, in communication with process manager 105, cause the results of that analysis to be rendered via one or more admin UI's 103. By way of example and without limitation, analysis engine 117 may compare the performance of two 11th-grade English classes at East High School, and may indicate that Mr. Smith's class has 25% comprehension of the material associated with standard “11.1.1” (in this example, “Understand unfamiliar words that refer to characters or themes in literature or history”), while Ms. Jones's class has 85% comprehension of that material. The school administration may then determine that Mr. Smith needs assistance in learning how to teach effectively concerning unfamiliar words that refer to characters or themes in literature or history.

Analysis engine 117 may use dynamic pivot data analysis and/or gap analysis heuristics and/or localized grid computing. Analysis engine 117 may further use cloud and/or clustering technologies to speed up data processing with large data sets. Analysis engine 117 may also aggregate one or more student information files 120 for referential and/or comparative analysis with curriculum and grade bias measurement. One or more student information files 120 may contain data, such as class and school identification data, which enables one or more student information files 120 to be aggregated for the collective analysis of a group, such as a class or school.

Reporting engine 118 may allow the generation of reports concerning any type of data which be extracted from the current embodiment, by transmitting the data to one or more printers or other output devices capable of rendering information in a form which is understandable by humans. Reporting engine 118 may also cause specific data, as requested via admin UI 103, to be transmitted to one or more widgets, i.e., one or more software engines which permit information to be displayed on a graphical user interface. Widgets may be resident on one or more remote devices, for example and without limitation, desktop computers, laptop computers, handheld devices, other portable devices, or any other device capable of rendering a graphical user interface. For example and without limitation, a teacher (or a parent, etc.) may use a widget resident on a handheld device for real-time monitoring of a student's progress with a particular assessment. (Admin UI 103 may also be used to monitor one or more students' real-time progress with any particular assessment.) Reporting engine 118 may allow the organization of data via dynamic statistical pivot points and/or cluster groups for efficient data mining. Reporting engine 118 may export data in any format, including but not limited to Microsoft Excel, CSV, HTML, or PDF documents.

It is to be understood that the functions of process manager 105, database manager 111, QCA engine 109, session manager 112, analysis engine 117, and/or reporting engine 118 may be performed by a single component or multiple components.

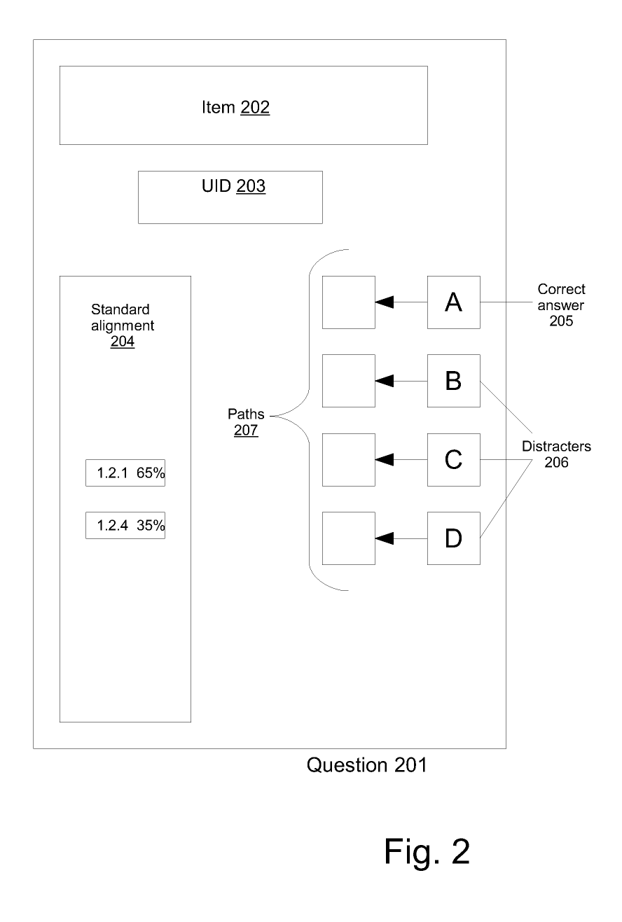

As shown in FIG. 2, there is depicted a functional block diagram illustrating in greater detail one implementation of one of questions 107 introduced in conjunction with FIG. 1. In FIG. 2, question 201 is a representative example of one of questions 107. Question 201 includes an item 202. Question 201 further includes a UID 203, as well as a standard alignment 204 for item 202. In the illustrated example, item 202 is aligned with standards 1.2.1 and 1.2.4. In this example, the relative weights of item 202 to standards 1.2.1 and standard 1.2.4 are provided—in this case, the weights are 65% to standard 1.2.1 and 35% to standard 1.2.4.

In the preferred embodiment, each question has one correct answer. (Whenever a question has more than one correct answer, the term “correct answer” as used herein refers to the most correct answer.) Each question also has one or more distracters, which are incorrect answers. Question 201 includes a correct answer 205, which in this particular example is choice “A” of the multiple choices provided. Question 201 also includes distracters 206, which in this case are choices “B”, “C”, and “D” of the multiple choices provided. In this example, each of correct answer 205 and distracters 206 has its own respective path 207. The path 207 may indicate a particular UID or other means of indicating a specific question containing an item to be presented in the event the student chooses, for example, the distracter “C” associated with question 201. Alternatively, path 207 may indicate one or more standards to which the distracter associated with path 207 applies, and session manager 112 may select one or more next questions which test the student's knowledge of the material associated with the one or more standards to which the distracter associated with path 207 applies. Correct answer 205 has a path 207 in the embodiment shown. Alternatively, a path may not be provided for correct answer 205. In that event, upon receiving correct answer 205 in response to item 202, session manager 112 may proceed by default to the next question, which next question is indicated by a selected assessment file 114 or determined by a algorithm associated with session manager 112.

As shown in FIG. 3, there is depicted a functional block diagram illustrating in greater detail one implementation of the map 108 introduced in conjunction with FIG. 1. In the embodiment shown, map 108 has a column labeled “UID”; each entry in this column refers to the UID 203 associated with a particular question 107, for example question 201. The middle column is labeled “response”. Assuming that question 201 has a UID 203 of “27042”, the four entries in the illustrated “response” column” refer to correct answer 205 (response “A” to item 202) and distracters 206 (responses “B”, “C”, and “D” to item 202). The rightmost column is labeled “path”, and indicates the UID of a particular question which is designated for presentation in the event the student chooses a particular response. For example, if the student chooses distracter “B” in response to item 202 in question 201, map 108 indicates the designated path is “27049”, which is the UID of the designated next question. Alternatively, for each distracter the path column in map 108 may indicate one or more standards associated with that particular distracter, and in the event the student chooses that distracter in response to item 202, session manager 112 may select a next question which is associated with the one or more standards associated with that particular distracter. The optional use of map 108 may, among other things, allow the generation of questions 107 without providing paths 207 for distracters 206.

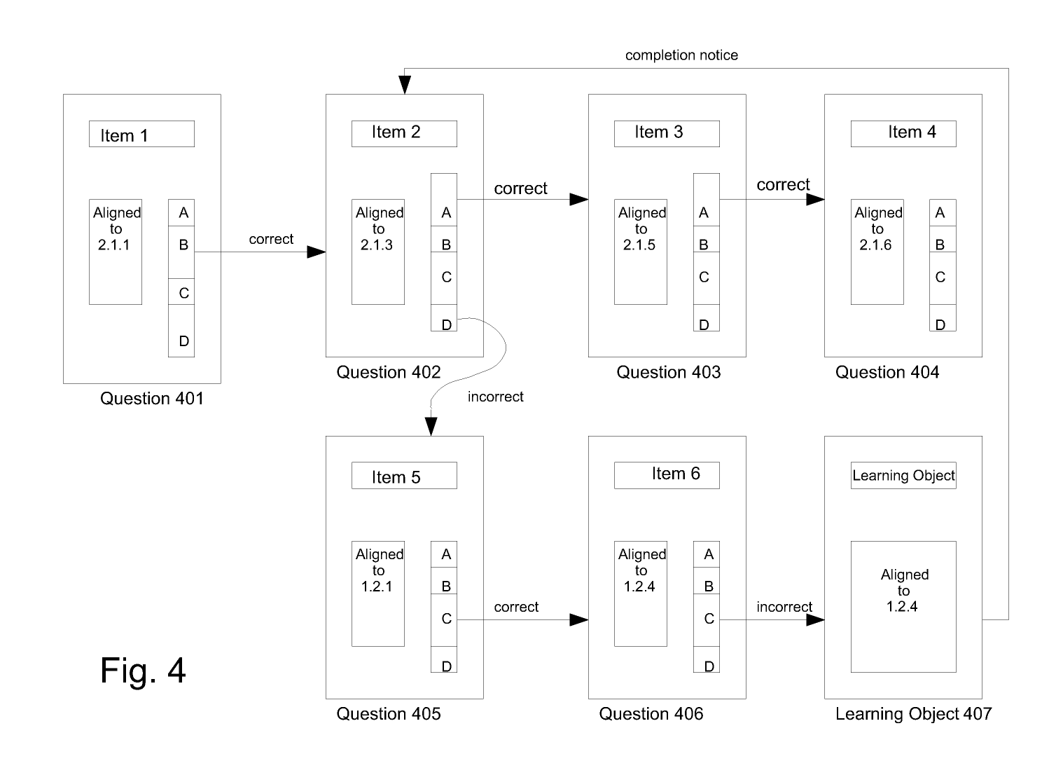

FIG. 4 illustrates by way of a directed graph diagram another embodiment of the present method, system, and product for adaptive assessment. In the example shown, a student chooses the correct answer for question 401, which contains an item aligned to standard 2.1.1. The student's selection of the correct answer indicates comprehension of the material associated with standard 2.1.1. Assuming the student continues to choose correct answers, the student proceeds to questions 402, 403, and 404 in that order.

However, as indicated by the illustrated example, the student may choose distracter “D” in response to the item associated with question 402. In the illustrated example, distracter “D” is aligned with standards 1.2.1 and 1.2.4. Accordingly, after the student chooses distracter “D”, the student is presented with question 405 (which includes an item aligned to standard “1.2.1”) and question 406 (which includes an item aligned to standard “1.2.4”). The student chooses correct answer “C” in response to the item in question 405, but subsequently chooses distracter “C” in response to the item in question 406.

In this example, the student's choice of distracter “C” in response to the item in question 406 confirms that the student has difficulty with the material associated with standard “1.2.4”. By choosing distracter “D” in response to the item associated with question 402, the student indicated he or she had difficulty with material related to either or both of standards “1.2.1” and “1.2.4”, since distracter “D” was aligned to both of those standards. Subsequently, by choosing correct answer “C” in response to the item in question 405, the student indicated he or she does not have difficulty with the material associated with standard “1.2.1,” since the item in question 405 is aligned to standard “1.2.1” and a correct answer indicates comprehension of the material associated with standard “1.2.1”. However, the student's subsequent choice of distracter “C” in response to the item in question 406 indicates a lack of comprehension of the material associated with standard “1.2.4”, since that is the standard to which the item in question 406 is aligned.

After the student confirms, via his or her response to question 406, that he or she lacks comprehension of the material related to standard “1.2.4”, session manager 112 may present the student with learning object 407, which is designed to aid in comprehending the material related to standard “1.2.4”. The student may review the material associated with learning object 407, and may perform one or more tasks as specified by learning object 407. Upon the student's completion of the review indicated by learning object 407, the student may transmit a completion notice to session manager 112 via student UI 110, which may be accomplished by clicking on a button labeled “done” or by any other means. Alternatively, a teacher who is monitoring the student's progress may transmit a completion notice to session manager 112 via admin UI 103. Upon the transmission of the completion notice, session manager 112 may cause question 402 to be presented once again, to ensure the student now comprehends the material associated with standard “2.1.3”.

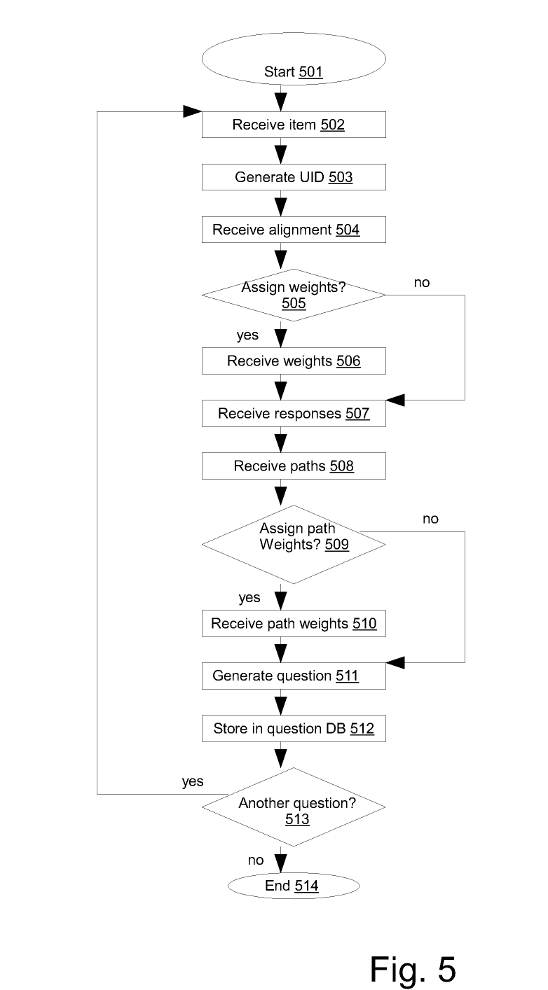

FIG. 5 is a schematic flow diagram generally illustrating yet another embodiment of the present method, system, and product for adaptive assessment. FIG. 5 illustrates one method for the generation of one or more questions 107. The process starts at step 501. At step 502, an item is received at QCA engine 109 via process manager 105. At step 503, a UID is generated for the question which is currently being created. The UID may be generated by QCA engine 109; alternatively the UID may be input by a user of one of UI's 102. Alternatively, one or more questions may be generated without UIDs, in which case session manager 112 may apply an algorithm for the selection of appropriate next questions by identifying the path associated with each chosen distracter and, for each chosen distracter, choosing a question with an item aligned to the path associated with that distracter.

At step 504, a standard alignment is received for the item which was received at step 502. At step 505, a decision is made whether or not to assign relative weights to one or more standards provided in connection with the standard alignment received at step 504. (If only one standard was provided, the process make skip forward at this point to step 507.) If it is determined that relative weights should be assigned for one or more standards provided in connection with the standard alignment received at step 504, the relative weights are received at step 506. If it is determined that relative weights should not be assigned for one or more standards provided in connection with the standard alignment received at step 504, the process skips to step 507.

At step 507, responses are received for the item which was received at step 502. Those responses may include one correct answer and one or more distracters. At step 508, respective paths are received for each distracter provided in connection with step 507, and optionally for the correct answer provided in connection with step 507.

At step 509, a decision is made whether or not to assign relative weights to standards associated with one or more paths provided in connection with step 508. If it is determined that relative weights should be assigned for one or more paths provided in connection with step 508, the relative weights for the standards are received at step 510. If it is determined that relative weights should not be assigned for one or more paths provided in connection with step 508, the process skips to step 511.

At step 511, the question which is currently being created is generated by combining the item, the UID, the standard alignment, the correct answer, the one or more distracters, and the paths into a file. At step 512, the question is stored in question database 106. At step 513, a decision is made whether or not to generate another question. If the response is affirmative, the process returns to step 502. If the response is negative, the process moves forward to step 514 and ends.

Alternatively, a procedure similar to the one outlined in FIG. 5 may be used to modify pre-existing questions 107 in question database 106.

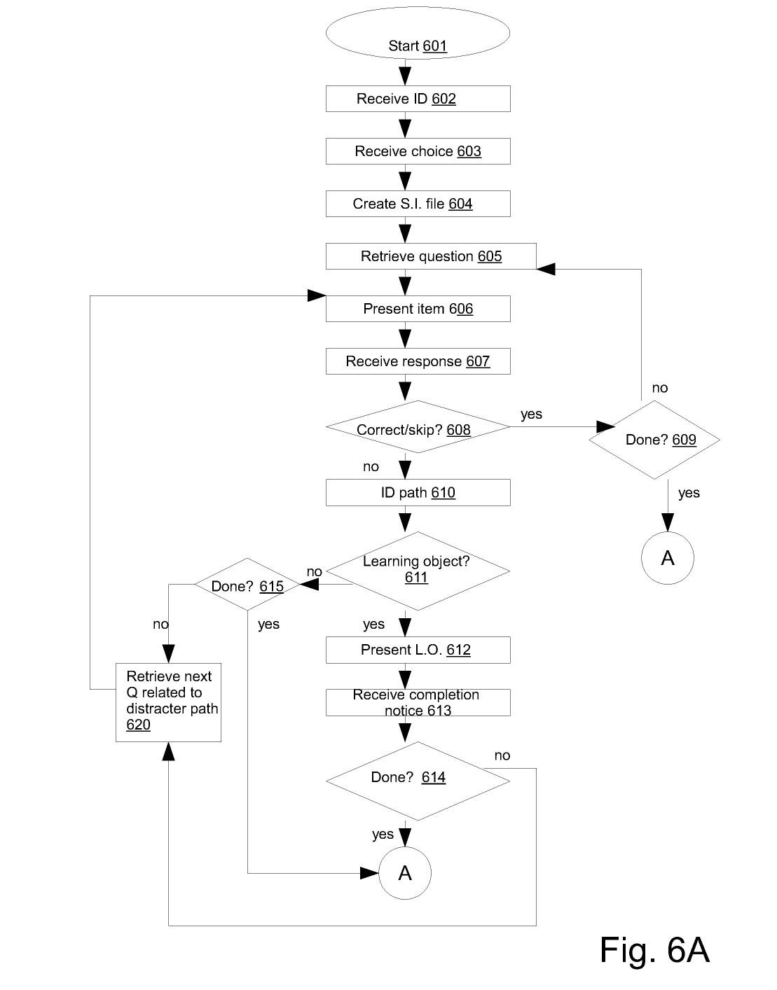

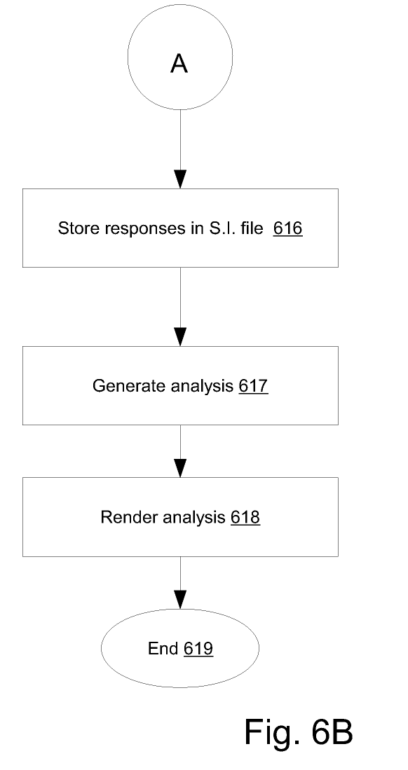

FIGS. 6A and 6B comprise a schematic flow diagram generally illustrating still another embodiment of the present method, system, and product for adaptive assessment. FIGS. 6A and 6B illustrate one method for assessing knowledge. The process starts at step 601. At step 602, the identity of the student who is responding to the assessment is received. At step 603, the choice of assessment is received. This may be determined by the student via student UI 110 or, alternatively, may be determined by a teacher or administrator via admin UI 103. At step 604, a student information file 120 is created. Alternatively, the data received during this process may be used to modify a pre-existing student information file 120.

At step 605, a question 107 is retrieved from question database 106. At step 606, the item associated with the selected question 107 is presented via student UI 110. The response is received at step 607. A student's response to one or more items within an assessment may be timed to highlight conceptual misunderstandings.

At step 608, it is determined whether the response is a correct answer, whether the student has indicated he or she wishes to skip the question, or whether the response is a distracter. If the response is correct, or the student has indicated a desire to skip the question, the process moves to step 609.

At step 609, it is determined whether the assessment is completed. This may be done by prompting the student, teacher, or other administrator for a decision; alternatively, session manager 112 may consult an internal algorithm, or may read the data in an assessment file 114 to determine whether the assessment is complete. If the assessment is complete, step 616 follows and the responses are stored in the student information file. At step 617, an analysis of the responses is generated. This may be an analysis of the student's strengths and weaknesses. For example and without limitation, the analysis may be a student comprehension signature which describes the student's strengths and weaknesses in relation to the standards associated with the items presented during the assessment. As another non-limiting example, at step 617, analysis engine 117 may conduct a collective analysis of more than one student information file—possibly one or more student information files associated with a particular class in a particular school. The collective analysis may be a class comprehension signature which describes the class's strengths and weaknesses in relation to the standards associated with the items presented during the assessment. At step 618, the analysis is rendered via one or more UI's 102. The word “render” is used herein according to its broadest meaning, and may include any operation which causes a graphical representation to be presented. The analysis may include one or more learning objects. At step 619, the process ends.

Returning to step 609, if it is determined that the assessment is incomplete, the process returns to step 605.

Returning to step 608, if it is determined that the response is a distracter, the process moves to step 610 and the distracter path is identified. At step 611, it is determined whether or not to present a learning object associated with one or more standards with which the distracter is aligned. This may be determined by an algorithm associated with session manager 112, or may be determined by a teacher or other administrator who is overseeing the assessment process, and who transmits a command to session manager 112 via admin UI 103 and process manager 105. If the decision to present a learning object is affirmative, the process moves to step 612, and the learning object is presented. At step 613, a completion notice is received by session manager 112, and the process moves to step 614. At step 614, it is determined whether the assessment is completed. If the assessment is complete, steps 616 through 619 follow as discussed above. If it is determined at step 614 that the assessment is not complete, the process moves to step 620. At step 620, one or more next questions related to the distracter path are retrieved. The process then returns to step 606, and one or more items associated with the one or more next questions related to the distracter path are presented. The process continues as discussed above.

Returning to step 611, if the decision to present a learning object is negative, the process moves to step 615. At step 615, it is determined whether the assessment is completed. If the assessment is complete, steps 616 through 619 follow as discussed above. If it is determined at step 615 that the assessment is not complete, the process moves to step 620 and continues as discussed above.

As will be appreciated by those persons skilled in the art, the present inventive method, system, and product, inclusive of one or more embodiments of its operation through software and hardware systems and the like, affords distinct advantages not previously available to schools and other organizations relating to the assessment of knowledge. The described method, system, and product allows a student's knowledge to be assessed in an adaptive manner in which next items are selected and presented in accordance with a student's weaknesses, as revealed by the student's choice of one or more distracters in response to one or more items. The creation of standards-aligned questions with one or more distracters, each distracter having its own respective path, allows schools to build a detailed semantic map of student knowledge levels—both on the individual and group levels. The collected data is immediately usable in the classroom, and allows analysis of each level of the education process.

During the assessment process, as described herein, a student receives next questions which test the student's particular weaknesses in response to student's choice of one or more distracters in previous items, both revealing the student's weaknesses and providing in-depth confirmation of those weaknesses. This embodiment also allows for real-time intervention and remediation. The present inventive method, system, and product readily faciliates a response-to-intervention (RTI) technique which provides immediate assistance to students who are finding it difficult to learn specific materials, Immediate assistance can be provided through the presentation of learning objects, as well as teacher override and interaction points, since teachers may use the present inventive system, method, and product to monitor the progress of one or more students in real time.

A student's responses to the items within an assessment may allow the student's instructors to diagnose the student's academic deficiencies with specificity and to develop remedial programs which are specifically tailored to remedy those deficiencies. Since each distracter may be aligned to one or more standards, responses to the items within an assessment may enable the user to obtain a multi-faceted view of a student's strengths and weaknesses in one or more academic fields. The present inventive method, system, and product allows enhancement of individualized education programs (IEPs) for up-to-the-minute differentiated teaching based on individual student needs. Assessments can be used to tie a standards-based curriculum to progress reports, identifying the learning needs of an individual student and working with that student's parents to build a plan for remediation. Professional development and data-mining experts can perform powerful gap analysis on all facets of the education process to identify areas which need improvement and to evaluate the effectiveness of professional development spending with hard data analyses.

The present inventive method, system, and product works well with standards-aligned curriculum and grades, and allows curricula to be tightly coupled to assessment items for ongoing evaluation of student comprehension. Responses to assessments can be aggregated for referential and comparative analysis with curriculum and grade bias measurement. The present inventive method, system, and product further allows the retention and growth of institutional knowledge. In any given assessment, flexible differentiated material may be tied together in linear and nonlinear segments. The present inventive method, system, and product allows community review of learning objects, assessments, and questions for collaborative review and creation. Up-to-date information about students who are having similar problems in similar classes can easily be obtained. The present inventive method, system, and product also maintains a digital account of problems without adding the burden of paperwork.

While this invention has been described in connection with what are currently considered to be the most practical and desirable embodiments, it is to be understood that the invention is not limited to the disclosed embodiments in any way as such are merely set forth for illustrative purposes. The present inventive system, method, and product are intended to cover an array of various modifications and equivalent arrangements, all of which are contemplated for inclusion within the scope and spirit of the disclosure and appended claims.

What is claimed is:

1. A computer-implemented method for creating a question for adaptive assessment, comprising, in no particular order, the steps of:
receiving an item having two or more potential responses, the two or more potential responses including a correct answer and a distracter;
receiving a standard alignment for the item, the standard alignment indicating the item is aligned with a first set of one or more standards;
receiving the correct answer and the distracter;
receiving a path for the distracter;
generating the question by combining the item, the standard alignment, the correct answer, the distracter, and the path; and
storing the question in a question database.

2. The method of claim 1, further comprising the step of assigning a relative weight for each standard in the first set of one or more standards.

3. The method of claim 1, wherein the path indicates alignment with a second set of one or more standards, further comprising the step of assigning a relative weight for each standard in the second set of one or more standards.

4. The method of claim 1, wherein the one or more potential responses include two or more distracters, each distracter having its own respective path.

5. The method of claim 1, further comprising, in no particular order, the steps of:
generating an assessment file by selecting a group of one or more questions; and
storing the assessment file in an assessment database.

6. A computer-readable medium having computer-executable instructions for performing the method of claim 1.

7. A computer-implemented method for assessing knowledge, comprising, in no particular order, the steps of:
retrieving a question from a question database;
presenting an item associated with the question;
receiving a distracter in response to the item;
identifying a path for the distracter;
retrieving one or more next questions from the question database;
presenting one or more next items, the one or more next items being associated with the path, each of the one or more next items being associated with its own respective question in the one or more next questions.

8. The method of claim 7, wherein the path indicates alignment with a first set of one or more standards, and each of the one or more items is associated with its own respective standard from within the first set of one or more standards.

9. The method of claim 7, further comprising the steps of:
retrieving a learning object from a learning object database;
presenting the learning object; and
receiving a completion notice.

10. The method of claim 7, further comprising the steps of:
receiving one or more responses to the one or more next items;
storing the one or more responses in a student information file; and
storing the student information file in a student information database.

11. The method of claim 10, further comprising the steps of:
generating an analysis of the student information file; and
rendering the analysis via a user interface.

12. The method of claim 10, further comprising the steps of:
generating a collective analysis of the student information file and one or more other student information files; and
rendering the collective analysis via a user interface.

13. The method of claim 7, further comprising the steps of:
receiving one or more responses to the one or more next items; and
reporting at least one of the one or more responses via a user interface.

14. A computer-readable medium having computer-executable instructions for performing the method of claim 7.

15. A system apparatus for assessing knowledge, the system apparatus comprising:
one or more user interfaces;
a question database configured to receive and store one or more questions, each of the one or more questions being associated with its own respective item;
a process manager which controls system operations;
a database manager which enables the retrieval and presentation of a first set of one or more questions via at least one of the one or more user interfaces;
a session manager which i) selects the first set of one or more questions for presentation via at least one of the one or more user interfaces, ii) receives a set of one or more responses to the items associated with the first set of one or more questions, and iii) stores the set of one or more responses in a student information file;
an analysis engine which generates an analysis of the student information file;
a student information database configured to receive and store one or more student information files; and
a question creation and alignment engine that enables i) creating a second set of one or more questions, wherein each of the one or more questions within the second set of one or more questions is associated with its own respective item, wherein at least one item has two or more potential responses, the two or more potential responses including a correct answer and a distracter, ii) aligning each item with its own respective set of one or more standards, iii) aligning the distracter with its own set of one or more standards, and iv) storing the second set of one or more questions in the question database.

16. The system apparatus of claim 15, further comprising a learning object database, wherein the database manager further enables the retrieval and presentation of one or more learning objects via at least one of the one or more user interfaces.

17. The system apparatus of claim 15, further comprising an assessment database which enables the storage of one or more assessment files, each assessment file including a list of questions, each question being associated with an item capable of being presented via at least one of the one or more user interfaces.

18. The system apparatus of claim 15, further comprising a reporting engine which enables the transmission of data extracted from one or more student information files to one or more output devices.
